(19) United States
(12) Patent Application Publication
(10) Pub. No.: US 2016/0173564 A1
(43) Pub. Date: Jun. 16, 2016

(54) HANDHELD DEVICE FOR CONTROLLING COMPUTER AND METHOD OF CONTROLLING COMPUTER

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: XI-HUAI HE, Wuhan (CN); CHUN-SHENG CHEN, New Taipei (TW)

(21) Appl. No.: 14/609,734

(22) Filed: Jan. 30, 2015

(30) Foreign Application Priority Data
Dec. 12, 2014 (CN) 201410760542.9

(51) Int. Cl. H04L 29/08; G06F 3/0488

(52) U.S. Cl. CPC H04L 67/025; G06F 3/04886

(57) ABSTRACT

A method of controlling a computer by a handheld device is employed in a handheld device. The method of controlling a computer includes the handheld device establishing a communication link with the computer, activating a computer-controlling function of the handheld device in response to an operation to the handheld device, displaying a user operation interface when the computer-controlling function is activated, sensing user operations on the user operation interface, determining a computer-controlling operation according to the sensed user operation, and transmitting the determined computer-controlling operation to the computer. A handheld device is also provided.

### CROSS-REFERENCE TO RELATED APPLICATIONS

This application claims priority to Chinese Patent Application No. 201410760542.9, filed on Dec. 12, 2014, the contents of which are incorporated by reference herein.

### FIELD

The subject matter herein relates to computer control.

### BACKGROUND

Computers are applied in every field. Users typically control the computer by mice and keyboards. When the mouse and the keyboard are damaged or the user is away from the computer, the user can not control the computer.

### BRIEF DESCRIPTION OF THE DRAWINGS

Implementations of the present technology will now be described, by way of example only, with reference to the attached figures.

FIG. 1 is a block diagram of a handheld device.

FIG. 2 is a flowchart of a method of controlling a computer.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

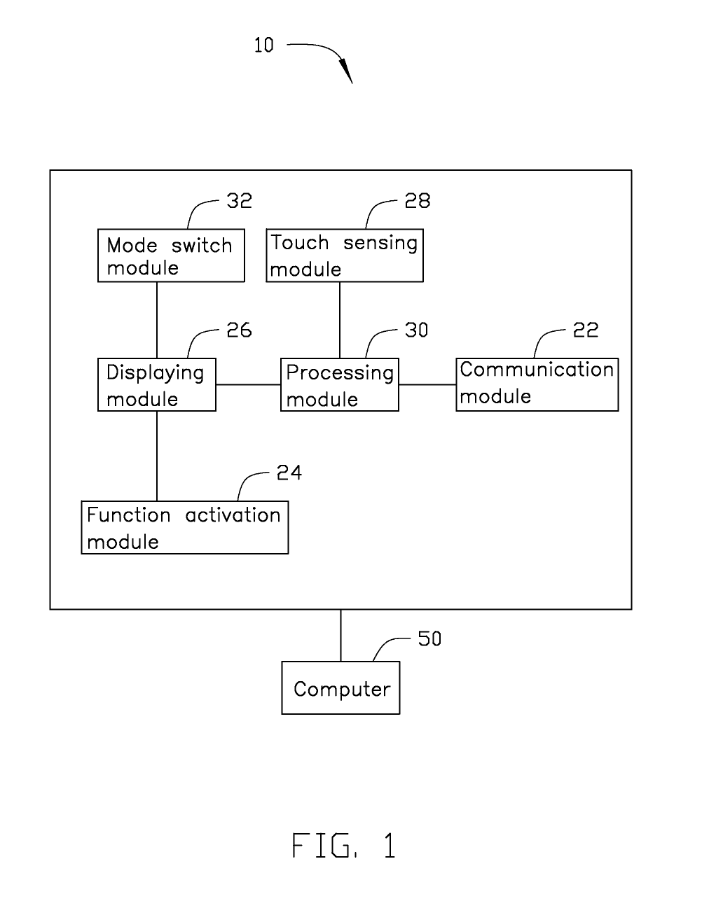

FIG. 1 illustrates a handheld device 10 can include a communication module 22, a function activation module 24, a displaying module 26, a touch sensing module 28, and a processing module 30. The handheld device 10 is configured to control a computer 50 by wired or wireless connection.

The communication module 22 is configured to transmit an identifying signal and establish a communication link with the computer 50 when the computer 50 has searched for the identifying signal. In the embodiment, the communication module 22 is a BLUETOOTH module. The BLUETOOTH module transmits a BLUETOOTH signal. The BLUETOOTH signal is self-identifying to the computer 50. However, the invention is not limited to any particular wired or wireless methodology.

The function activation module 24 is configured to activate a computer-controlling function in response to an operation to the handheld device 10. In the embodiment, the handheld device 10 is a smart phone. The function activation module 24 is an application program installed in the handheld device 10. The displaying module 26 is configured to display a user operation interface when the computer-controlling function is activated. The touch sensing module 28 is configured to sense user operations on the user operation interface. The processing module 30 is configured to determine a computer-controlling operation according to the sensed user operation on the user operation interface. The communication module 22 is further configured to transmit the determined computer-controlling operation to the computer 50. The determined computer-controlling operation is configured to control the computer 50.

In the embodiment, the handheld device 10 further includes a mode switch module 32. The mode switch module 32 is configured to allow control of the handheld device 10 by a mouse mode or by a keyboard mode in response to an operation to the handheld device 10 when the computer-controlling function is activated. When the handheld device 10 is in the mouse mode, the displaying module 26 displays a first touch interface. The first touch interface may include a virtual keyboard interface and a handwriting input interface. In another embodiment, the first touch may be entirely a virtual keyboard interface or entirely a handwriting input interface. When the handheld device 10 is in the keyboard mode, the displaying module 26 displays a second touch interface.

The touch sending module 28 senses touch input operations on a first touch interface and senses touch sliding operations on a second touch interface. The processing module 30 determines a user input according to the sensed touch input operations and determines a track of a cursor of the computer 50 according to the sensed touch sliding operations. In one embodiment, when the communication link between the computer 50 and the handheld device 10 is established, the computer 50 transmits length and width dimensional information of a display of the computer 50 to the handheld device 10. The communication module 22 receives the length and width dimensional information. According to the length and width dimensional information and length and width dimensional information of the second touch interface, the processing module 30 establishes a scaled or other relationship between them and determines the track of the cursor of the computer 50 according to the scaled or other relationship and the sensed touch sliding operations.

The communication module 22 transmits the determined user input and the determined track of the cursor to the computer 50. The computer 50 moves the cursor based on the determined track of the cursor, to reflect the user input.

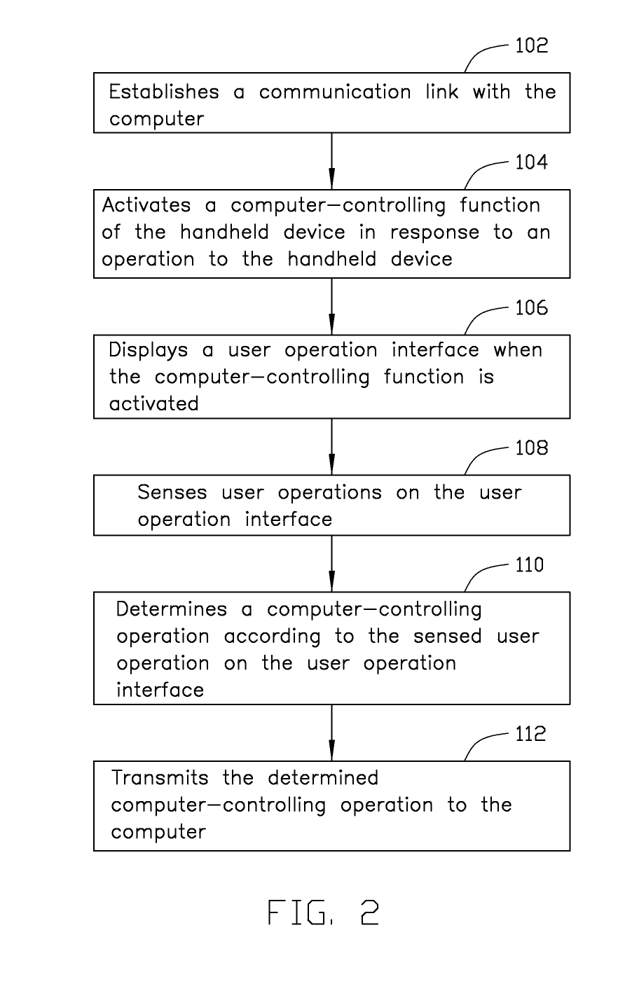

FIG. 2 illustrates a flowchart of a method of controlling a computer. The illustrated order of blocks in FIG. 2 is illustrative only and the order of the blocks can change. Additional blocks can be added or fewer blocks may be utilized without departing from this disclosure. The example method can begin at block 102.

At block 102, the communication module 22 establishes a communication link with the computer 50.

At block 104, the function activation module 24 activates a computer-controlling function of the handheld device 10 in response to an operation to the handheld device 10.

At block 106, the displaying module 26 displays a user operation interface when the computer-controlling function is activated.

At block 108, the touch sensing module 28 senses user operations on the user operation interface.

At block 110, the processing module 30 determines a computer-controlling operation according to the sensed user operation on the user operation interface.

At block 112, the communication module 22 transmits the determined computer-controlling operation to the computer 50.

In detail, at block 106, when the handheld device 10 is in a mouse mode, the displaying module 26 displays a first touch interface, and when the handheld device 10 is in a keyboard mode, the displaying module 26 displays a second touch interface. The first touch interface may include a virtual keyboard interface and a handwriting input interface. In another embodiment, the first touch may be only a virtual keyboard interface or only a handwriting input interface.

In detail, at block 108, the touch sending module 28 senses touch input operations on the first touch interface and senses touch sliding operations on the second touch interface.

In detail, at block 110, the processing module 30 determines user inputs according to the sensed touch input operations and determines a track of a cursor of the computer 50 according to the sensed touch sliding operations. In one embodiment, when the communication link between the computer 50 and the handheld device 10 is established, the computer 50 transmits length and width dimensional information of a display of the computer 50 to the handheld device 10. The communication module 22 receives the length and width dimensional information. According to the length and width dimensional information of the display of the computer 50 and length and width dimensional information of the second touch interface, the processing module 30 can establish a scaled or other relationship between them and determines the track of the cursor of the computer 50 according to the scaled or other relationship and the sensed touch sliding operations.

In detail, at block 112, the communication module 22 transmits the determined user input and the determined track of the cursor to the computer 50.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A handheld device configured to control a computer, the handheld device comprising:
a communication module configured to establish a communication link with the computer;
a function activation module configured to activate a computer-controlling function in response to an operation to the handheld device;
a displaying module configured to display a user operation interface when the computer-controlling function is activated;
a touch sensing module configured to sense user operations on the user operation interface; and
a processing module configured to determine a computer-controlling operation according to the sensed user operation on the user operation interface;
the communication module further configured to transmit the determined computer-controlling operation to control the computer.

2. The handheld device as claimed in claim 1, further comprising:
a mode switch module configured to allow control of the handheld device by a mouse mode or by a keyboard mode in response to an operation to the handheld device when the computer-controlling function is activated.

3. The handheld device as claimed in claim 2, wherein when the handheld device is in the mouse mode, the displaying module displays a first touch interface, and when the handheld device is in the keyboard mode, the displaying module displays a second touch interface.

4. The handheld device as claimed in claim 3, wherein the first touch interface is entirely a virtual keyboard interface.

5. The handheld device as claimed in claim 3, wherein the first touch comprises a virtual keyboard interface and a handwriting input interface.

6. The handheld device as claimed in claim 3, wherein the touch sending module senses touch input operations on the first touch interface and senses touch sliding operations on the second touch interface.

7. The handheld device as claimed in claim 6, wherein the processing module determines user input according to the sensed touch input operations and determines a track of a cursor of the computer according to the sensed touch sliding operations.

8. The handheld device as claimed in claim 1, wherein the handheld device is a smart phone.

9. The handheld device as claimed in claim 8, wherein the function activation module is an application program installed in the handheld device.

10. A method of controlling computer employed in a handheld device and configured to control a computer, the method of controlling computer comprising:
establishing a communication link between the computer and the handheld device;
activating a computer-controlling function of the handheld device in response to an operation to the handheld device;
displaying a user operation interface when the computer-controlling function is activated;
sensing user operations on the user operation interface;
determining a computer-controlling operation according to the sensed user operation; and
transmitting the determined computer-controlling operation to the computer for controlling the computer.

11. The method of controlling computer as claimed in claim 10, further comprising:
selecting the handheld device in a mouse mode or in a keyboard mode.

12. The method of controlling computer as claimed in claim 11, wherein when the handheld device is in a mouse mode, displaying a first touch interface, and when the handheld device is in a keyboard mode, displaying a second touch interface.

13. The method of controlling computer as claimed in claim 12, wherein the first touch interface comprises a virtual keyboard interface and a handwriting input interface.

14. The method of controlling computer as claimed in claim 12, wherein “sensing user operations on the user operation interface” comprising sensing touch input operations on the first touch interface and sensing touch sliding operations on the second touch interface.

15. The method of controlling computer as claimed in claim 14, wherein “determining a computer-controlling operation according to the sensed user operation” comprises determining user input according to the sensed touch input operations and determining a track of a cursor of the computer according to the sensed touch sliding operations.

16. A method of controlling computer by a handheld device, comprising:
establishing a communication link between the computer and the handheld device;
activating a computer-controlling function of the handheld device in response to an operation to the handheld device;
receive dimensional information of a display of the computer from the computer;
displaying an interface, on the hand-held device, in response to the computer-controlling function being activated, the displaying comprising scaling the interface to match the received dimensional information;
sensing data input from the interface;
determining a computer-controlling operation according to the sensed data input; and
transmitting the determined computer-controlling operation to the computer for controlling the computer.

17. The method of controlling computer as claimed in claim 16, further comprising:
selecting the handheld device in a mouse mode or in a keyboard mode.

18. The method of controlling computer as claimed in claim 17, wherein when the handheld device is in a mouse mode, displaying a first touch interface, and when the handheld device is in a keyboard mode, displaying a second touch interface.

19. The method of controlling computer as claimed in claim 18, wherein “sensing data input from the interface” comprising sensing data input on the first touch interface and sensing data input on the second touch interface.

20. The method of controlling computer as claimed in claim 19, wherein “determining a computer-controlling operation according to the sensed data input” comprises determining user input according to the sensed data input on the first touch interface and determining a track of a cursor of the computer according to the sensed data input on the second touch interface.
